(19) United States
(12) Patent Application Publication
(10) Pub. No.: US 2005/0283506 A1
(43) Pub. Date: Dec. 22, 2005

(54) Attenuator, data signal processor, method for acquiring attenuation of attenuator, recording medium, and computer data signal

(76) Inventor: Toshiya Kamibayashi, Tokyo (JP)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/153,843

(22) Filed: Jun. 15, 2005

(30) Foreign Application Priority Data
Jun. 17, 2004 (JP) 2004-180086

(51) Int. Cl. G06F 7/00

(52) U.S. Cl. 708/200

(57) ABSTRACT

An address generator is supplied with a designated gain GT, and generates exponent data n and an address of mantissa A. The address of mantissa A is set based on an accuracy of the designated gain GT. A mantissa-coefficient acquiring unit is so structured as to acquire a mantissa-coefficient k based on an equation acquired in accordance with a relationship between the exponent data n and mantissa data for each address of mantissa A. A coefficient data acquiring section and a mantissa data acquiring section both included in the mantissa-coefficient acquiring unit generate a coefficient a and mantissa data d1, respectively, based on the address of mantissa A, whereby the mantissa-coefficient k can be acquired for the exponent data n with a high accuracy for each address of mantissa A.

### BACKGROUND OF THE INVENTION

1. Field of the Invention

The present invention relates to an attenuator, a method and a program for acquiring attenuation thereof.

2. Description of the Related Art

Conventionally, an attenuator which adjusts the amount of gain of a digital signal of audio data, one used for telecommunication, etc. has been known (see, for instance, Unexamined Japanese Patent Application KOKAI Publication No. 2001-282296 (page 4 and FIG. 1)).

In the conventional attenuators, one that controls the gain of −96.0 dB to +90.0 dB by a step of 0.5 dB first divides a designated gain into the value of exponent and the address of mantissa.

The conventional attenuator bit-shifts input data based on the value of the divided exponent. Accordingly, the attenuator adjusts the amount of gain at 6 dB step. The attenuator multiplies the shifted input data by a set coefficient based on the address of the divided mantissa.

As the amount of gain when shifted by 1 bit becomes 20×log(2)≈6.02 or 20×log(½)≈−6.02, an error between the designated gain and the actual gain becomes large when the amount of gain is significantly large or small.

Simple multiplication of the coefficient based on the address of the mantissa enlarges the error when the mantissa set in the range of 0 to 5.5 dB is multiplied.

### SUMMARY OF THE INVENTION

Accordingly, the present invention has been made in consideration of the situations, and it is an object of the present invention to provide an attenuator, and a method for obtaining attenuation of the attenuator which is able to reduce an error between designated attenuation and actual one.

In order to achieve the aforementioned objects, an attenuator according to the first aspect of the present invention, is an attenuator for attenuating an input value in accordance with a designated attenuation which comprises:

a data storing unit which stores exponents and the number of steps between the exponents based on an accuracy of the designated attenuation in a floating-point representation, and stores address data of mantissa in association with each step;

a data acquiring unit which associates the designated attenuation with the exponents and the address data of mantissa both stored by the data storing unit, and acquires an exponent of the designated attenuation and the address data of mantissa;

a mantissa acquiring unit which acquires a mantissa of the designated attenuation from the exponent and an address of mantissa both acquired by the data acquiring unit, in accordance with a relationship between an exponent and mantissa of an attenuation, which relationship is acquired beforehand for each of the address data of mantissa; and

an attenuating unit which attenuates the input value in accordance with the attenuation set based on the exponent acquired by the data acquiring unit and the mantissa acquired by the mantissa acquiring unit.

The mantissa acquiring unit may acquire the mantissa of the designated attenuation in accordance with the relationship between an exponent and mantissa of an attenuation, which relationship is acquired beforehand for each of the address data of mantissa and represented by an equation (1) given below:
m=a_{Address}×n +b_{Address} (1),
wherein:
m is mantissa;
n is exponent; and
a_{Address} and b_{Address} are coefficients set for each address of mantissa.

The mantissa acquiring unit may prestore the coefficients a_{Address} and b_{Address} necessary for acquiring the mantissa m in a table in association with address data of mantissa, acquire the coefficients associated with the address data of mantissa acquired by the data acquiring unit, and acquire the mantissa of the designated attenuation based on the acquired coefficients and the exponent acquired by the data acquiring unit.

The mantissa acquiring unit may acquire the coefficients a_{Address} and b_{Address} necessary for acquiring the mantissa m based on a polynomial equation in which address data of mantissa is an argument, and acquire the mantissa of the designated attenuation based on the acquired coefficients and the exponent acquired by the data acquiring unit.

The attenuating unit may comprise:

an exponent attenuating unit which performs attenuation in accordance with the exponent acquired by the data acquiring unit; and

a mantissa attenuating unit which performs attenuation in accordance with the mantissa acquired by the mantissa acquiring unit.

The exponent attenuating unit may be constituted by a bit-shifting circuit which bit-shifts an input value to the exponent attenuating unit by a number of bits corresponding to the exponent acquired by the data acquiring unit.

The mantissa attenuating unit may be constituted by a multiplier which multiplies an input value to the mantissa attenuating unit by the mantissa acquired by the mantissa acquiring unit.

The radix for representing the designated attenuation in floating-point format may be 2.

A data signal processor according to the second aspect of the present invention is a data signal processor which constitutes an attenuator by realizing the data storing unit, the data acquiring unit, the mantissa acquiring unit, and the attenuating unit according to the first aspect of the present invention.

A method for acquiring attenuation of an attenuator according to the third aspect of the present invention comprises the procedures of:

storing exponents and a number of steps between the exponents based on an accuracy of a designated attenuation in a floating-point representation, and storing address data of mantissa in association with each step;

associating the designated attenuation with the stored exponents and the stored address data of mantissa, and acquiring an exponent of the designated attenuation and the address data of mantissa; and

acquiring a mantissa of the designated attenuation from the acquired exponent and an acquired address of mantissa, in accordance with a relationship between an exponent and mantissa of an attenuation, which relationship is acquired beforehand for each of the address data of mantissa.

A recording medium according to the fourth aspect of the present invention records a program for allowing a computer to execute the procedures of:

storing exponents and a number of steps between the exponents based on an accuracy of a designated attenuation in a floating-point representation, and storing address data of mantissa in association with each step;

associating the designated attenuation with the stored exponents and the stored address data of mantissa, and acquiring an exponent of the designated attenuation and the address data of mantissa; and

acquiring a mantissa of the designated attenuation from the acquired exponent and an acquired address of mantissa, in accordance with a relationship between an exponent and mantissa of an attenuation, which relationship is acquired beforehand for each of the address data of mantissa.

An attenuator according to the fifth aspect of the present invention, is an attenuator for attenuating an input value in accordance with a designated attenuation which comprises:

data storing means for storing exponents and a number of steps between the exponents based on an accuracy of the designated attenuation in a floating-point representation, and storing address data of mantissa in association with each step;

data acquiring means for associating the designated attenuation with the exponents and the address data of mantissa both stored by the data storing means, and acquiring an exponent of the designated attenuation and the address data of mantissa;

mantissa acquiring means for acquiring a mantissa of the designated attenuation from the exponent and an address of mantissa both acquired by the data acquiring means, in accordance with a relationship between an exponent and mantissa of an attenuation, which relationship is acquired beforehand for each of the address data of mantissa; and

attenuating means for attenuating the input value in accordance with the attenuation set based on the exponent acquired by the data acquiring means and the mantissa acquired by the mantissa acquiring means.

A computer data signal according to the sixth aspect of the present invention, is a computer data signal which is embedded in a carrier wave and represents a program for controlling the computer to execute the procedures of:

storing exponents and a number of steps between the exponents based on an accuracy of a designated attenuation in a floating-point representation, and storing address data of mantissa in association with each step;

associating the designated attenuation with the stored exponents and the stored address data of mantissa, and acquiring an exponent of the designated attenuation and the address data of mantissa; and

acquiring a mantissa of the designated attenuation from the acquired exponent and an acquired address of mantissa, in accordance with a relationship between an exponent and mantissa of an attenuation, which relationship is acquired beforehand for each of the address data of mantissa.

### BRIEF DESCRIPTION OF THE DRAWINGS

These objects and other objects and advantages of the present invention will become more apparent upon reading of the following detailed description and the accompanying drawings in which:

FIG. 1 is a block diagram illustrating the structure of an attenuator according to an embodiment of the present invention;

FIG. 2 is an explanatory diagram illustrating a relationship between exponent data and mantissa data for each address of mantissa;

FIG. 3 is an explanatory diagram illustrating an example of a table for acquiring exponent data n and mantissa data A for a designated gain GT;

FIG. 4 is an explanatory diagram illustrating a coefficient a which is set for each address of mantissa;

FIG. 5 is an explanatory diagram illustrating a coefficient b which is set for each address of mantissa;

FIG. 6 is an explanatory diagram illustrating a relationship between the designated gain and mantissa data m,

FIG. 7 is an explanatory diagram illustrating a relationship between the designated gain GT of the attenuator of the embodiment and an obtained gain GR;

FIG. 8 is an explanatory diagram illustrating a relationship between the designated gain GT of the conventional attenuator and an obtained gain GR;

FIG. 9 is an explanatory diagram comparing an error caused by the attenuator of the embodiment with that of the conventional attenuator;

FIG. 10 is an explanatory diagram illustrating a relationship between the address of mantissa and the coefficient a, as an applicational example of the attenuator according to the embodiment;

FIG. 11 is an explanatory diagram illustrating a relationship between the address of mantissa and the coefficient b, as the applicational example of the attenuator according to the embodiment;

FIG. 12 is a block diagram illustrating the structure of a coefficient data acquiring section, as the applicational example of the attenuator according to the embodiment; and

FIG. 13 is a block diagram illustrating the structure of the coefficient data acquiring section, as the applicational example of the attenuator according to the embodiment.

### DETAILED DESCRIPTION OF THE PREFERRED EMBODIMENT

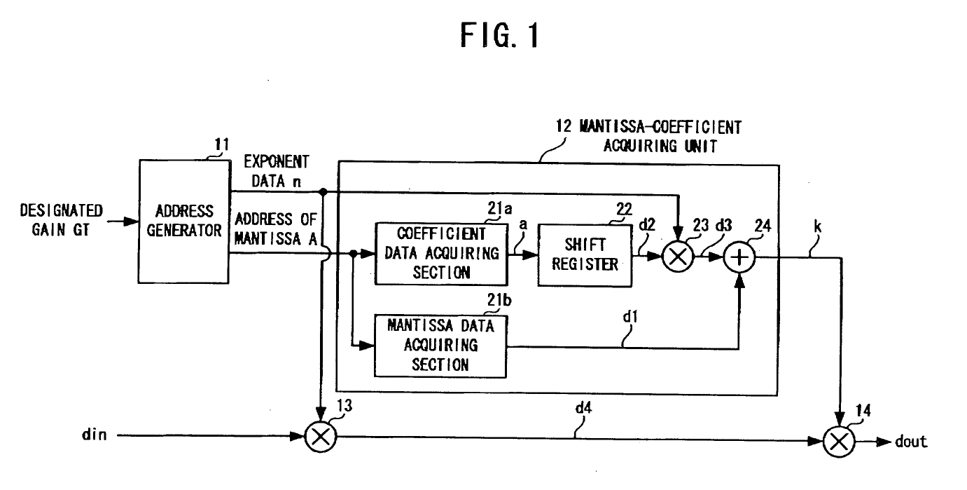

An attenuator according to a preferred embodiment will now be described with reference to the accompanying drawings. FIG. 1 illustrates the structure of the attenuator of the embodiment.

The attenuator of the embodiment is one that is so structured as to acquire the attenuation of input data din in accordance with the following method.

In general, the amount of gain Gain which represents attenuation can be expressed by an equation (2) given below.

$$\begin{matrix}Gain = 20 \times log ( ( m + {2}^{7} ) / {2}^{7} \times {2}^{n} ) \\ = 20 \times log ( ( m + {2}^{7} ) \times {2}^{n - 7} )\end{matrix} \qquad ( 2 )$$

where m is the variable number of mantissa, and n is the variable number of exponent.

When the amount of gain Gain is designated from the equation (2), mantissa data m, which is a positive decimal fraction of the common logarithm, can be represented by an equation (3) given below.
M=10^{Gain/20}×2⁷⁻ⁿ−2⁷ (3)

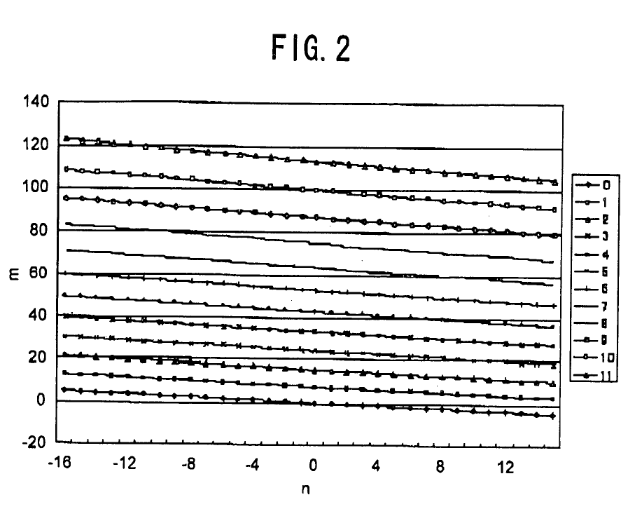

The relationship between exponent data n and the mantissa data m, acquired for each address of mantissa based on the equation (3), becomes a graph as illustrated in FIG. 2 can be obtained. The relationship, which was acquired by experiments, etc., is approximated by an equation (4) given below.
m=a×n+b (4)

where a and b are coefficients.

With the address of mantissa being A, acquiring the mantissa data m from the exponent data n and the address of mantissa A in accordance with the equation (4) can further reduce an error between the designated gain and an actual gain.

Accordingly, the attenuator of the embodiment comprises an address generator 11, a mantissa-coefficient acquiring unit 12, a bit-shifting unit 13 and a multiplier 14.

The address generator 11 is supplied with the designated gain GT, and generates the exponent data n and the address of mantissa A. In controlling the amount of gain from −96 dB to +95.5 dB by a step of 0.5 dB, the exponent data n is given by 5 bits, and the address of mantissa A is given by 4 bits.

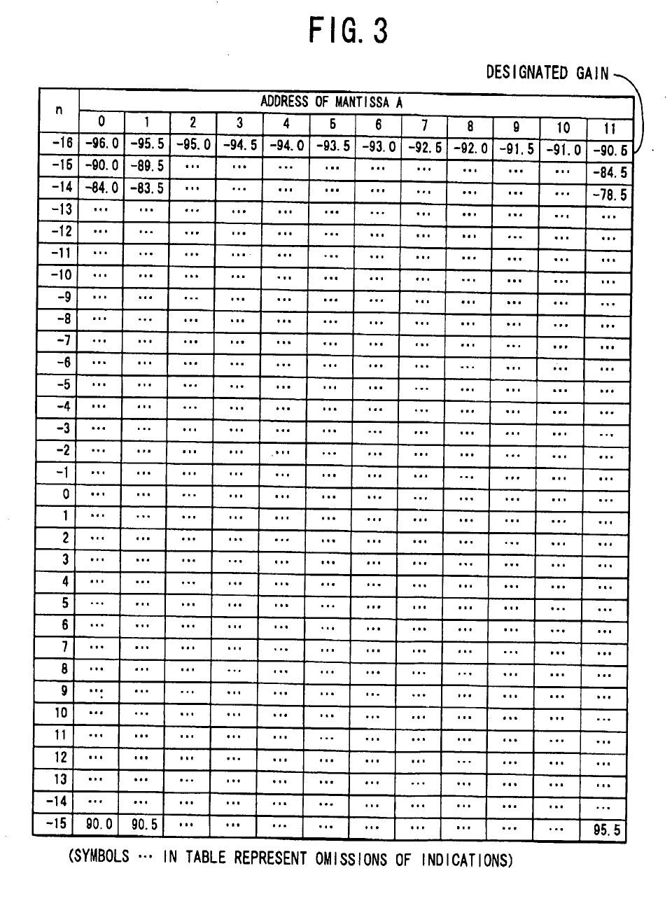

FIG. 3 illustrates an example of a table for acquiring the exponent data n and the mantissa data A for the designated gain GT. This table was acquired based on the graph of FIG. 2. As illustrated in FIG. 3, the exponent data n and the number of steps between the exponents are set based on the 0.5 dB accuracy of the designated gain GT in a floating-point representation. The address of mantissa A is set from 0 to 11 in association with the individual steps.

When the designated gain of, for instance, −96.0 dB is supplied to the address generator 11, the address generator 11 acquires the exponent data n of −16, and the address of mantissa A of 0. The address generator 11 corresponds to, for instance, a data setting unit and a data acquiring unit.

The address generator 11 supplies the exponent data n, which is acquired based on the table, to the bit-shifting unit 13 and the mantissa-coefficient acquiring unit 12, and also supplies the address of mantissa A to the mantissa-coefficient acquiring unit 12.

The mantissa-coefficient acquiring unit 12, which corresponds to a mantissa acquiring unit, for example, acquires mantissa-coefficient k of (m+2⁷) based on the address of mantissa A and the exponent data n both supplied from the address generator 11. The mantissa-coefficient acquiring unit 12 includes a coefficient data acquiring section 21a, a mantissa data acquiring section 21b, a shift register 22, a multiplier 23 and an adder 24.

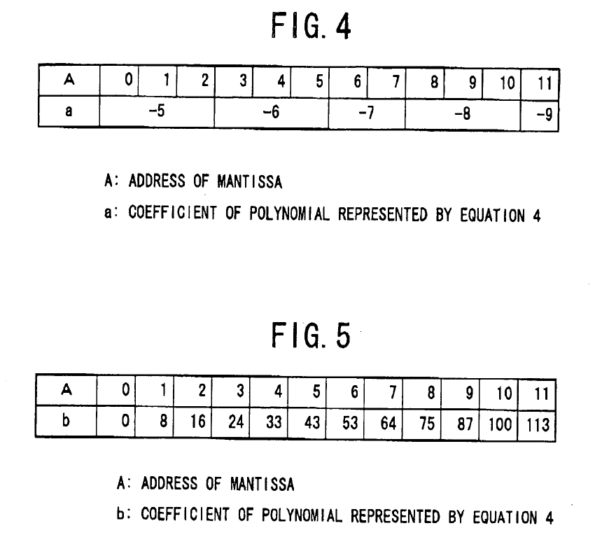

The coefficient data acquiring section 21a acquires the coefficient a represented in the equation (4) based on the address of mantissa A supplied from the address generator 11. The coefficient data acquiring section 21a prestores a table representing a relationship between the address of mantissa A and the coefficient a both illustrated in FIG. 4.

This table is generated based on the graph illustrated in FIG. 2. The coefficient a is set for each address of mantissa A. For instance, when the address of mantissa A of 0 is supplied from the address generator 11, the coefficient data acquiring section 21a acquires the coefficient a of −5, based on the table illustrated in FIG. 4. The coefficient data acquiring section 21a supplies the acquired coefficient a to the shift register 22.

The mantissa data acquiring section 21b acquires the mantissa data d1 of (b+2⁷) based on the address of mantissa A supplied from the address generator 11. The mantissa data acquiring section 21b prestores a table representing a relationship between the address of mantissa A and the coefficient b, illustrated in FIG. 5.

This table is generated based on the graph illustrated in FIG. 2. The coefficient b is set for each address of mantissa A. For instance, when the address of mantissa A of 0 is supplied from the address generator 11, the mantissa data acquiring section 21b acquires the coefficient b of 0, based on the table illustrated in FIG. 5. The mantissa data acquiring section 21b acquires the coefficient b, adds 2⁷ to the coefficient b, and supplies mantissa data d1 of (b+2⁷) to the adder 24.

By bit-shifting the coefficient a, acquired by the coefficient data acquiring section 21, to the right by 4 bits, the shift register 22 multiplies the coefficient by 1/16, thereby generating data d2. The shift register 22 supplies the generated data d2 to the multiplier 23.

The multiplier 23 multiplies the data d2 supplied from the shift register 22 by the coefficient data n supplied from the address generator 11, thereby generating data d3. The multiplier 23 supplies the generated data d3 to the adder 24.

The adder 24 adds the data d3 supplied from the multiplier 23 to the data d1 supplied from the mantissa data acquiring section 21b, thereby generating the mantissa-coefficient k. The mantissa-coefficient k can be represented by an equation (5) given below.
k=m+2⁷ (5)

The mantissa-coefficient acquiring unit 12 supplies the mantissa-coefficient k to the multiplier 14.

The bit-shifting unit 13 bit-shifts the input data din based on the exponent data n supplied from the address generator 11, thereby generating data d4. The multiplier 14 multiplies the data d4 generated by the bit-shifting unit 13 by the mantissa-coefficient k output from the mantissa-coefficient acquiring unit 12, thereby generating output data dout. The attenuator outputs the output data dout generated by the multiplier 14. The bit-shifting unit 13 and the multiplier 14 correspond to, for instance, an attenuation unit.

Next, operations of the attenuator of the embodiment will now be explained.

When the designated gain GT of, for instance, −96.0 dB is supplied to the address generator 11, the address generator 11 generates the exponent data n of −16 and the address of mantissa A of 0 based on the table illustrated in FIG. 3. The address generator 11 supplies the generated exponent data n of −16 and the generated address of mantissa A of 0 to the mantissa-coefficient acquiring unit 12.

The coefficient data acquiring section 21a of the mantissa-coefficient acquiring unit 12 generates the coefficient a of −5 from the table illustrated in FIG. 4 based on the supplied address of mantissa A of 0. The coefficient data acquiring section 21a supplies the coefficient a of −5 to the shift register 22.

The mantissa data acquiring section 21b acquires the coefficient b of 0 from the table illustrated in FIG. 5 based on the address of mantissa A of 0 supplied from the address generator 11. The mantissa data acquiring section 21b adds 2⁷ to the acquired coefficient b of 0, thereby generating the mantissa data d1 of 2⁷. The mantissa data acquiring section 21b supplies the generated mantissa data d1 of 2⁷ to the adder 24.

The shift register 22 bit-shifts the coefficient a of −5, supplied from the coefficient data acquiring section 21a, to the right by 4 bits, thereby generating the data d2 of − 5/16. The shift register 22 supplies the generated data d2 of − 5/16 to the multiplier 23. The multiplier 23 multiplies the exponent data n of −16 supplied from the address generator 11 by the data d2 of − 5/16 supplied from the shift register 22, thereby generating the data d3 of 5. The multiplier 23 supplies the generated data d3 of 5 to the adder 24.

The adder 24 adds the data d2 of 5 supplied from the multiplier 23 to the mantissa data d1 of 2⁷ supplied from the mantissa data acquiring section 21b, thereby generating the mantissa-coefficient k of 5+2⁷. The mantissa-coefficient acquiring unit 12 supplies the mantissa-coefficient k of 5+2⁷ generated by the adder 24 to the multiplier 14.

The bit-shifting unit 13 bit-shifts the input data din by n−7=−23, thereby generating the data d4. The bit-shifting unit 13 supplies the generated data d4 to the multiplier 14.

The multiplier 14 multiplies the data d4 supplied from the bit-shifting unit 13 by the mantissa-coefficient k of 5+2⁷ supplied from the mantissa-coefficient acquiring unit 12, thereby generating the output data dout. The attenuator outputs the output data dout generated by the multiplier 14.

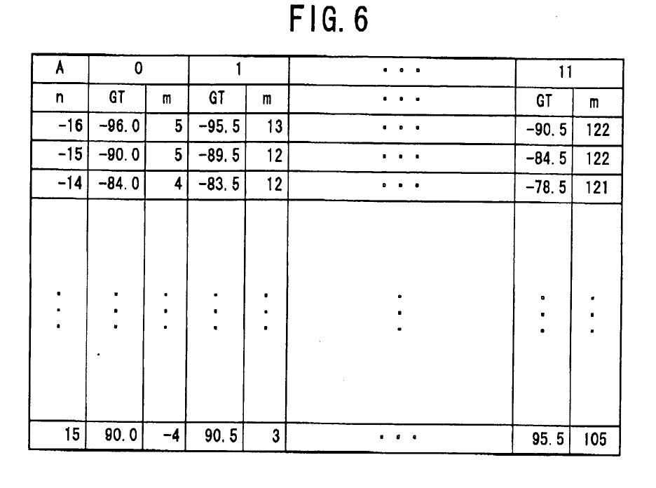

In comparing the mantissa-coefficient k of 5+2⁷ generated by the adder 24 with the equation (5), the mantissa data m is to be equal to 5. The relationship between the designated gain GT and the mantissa data m is illustrated in FIG. 6.

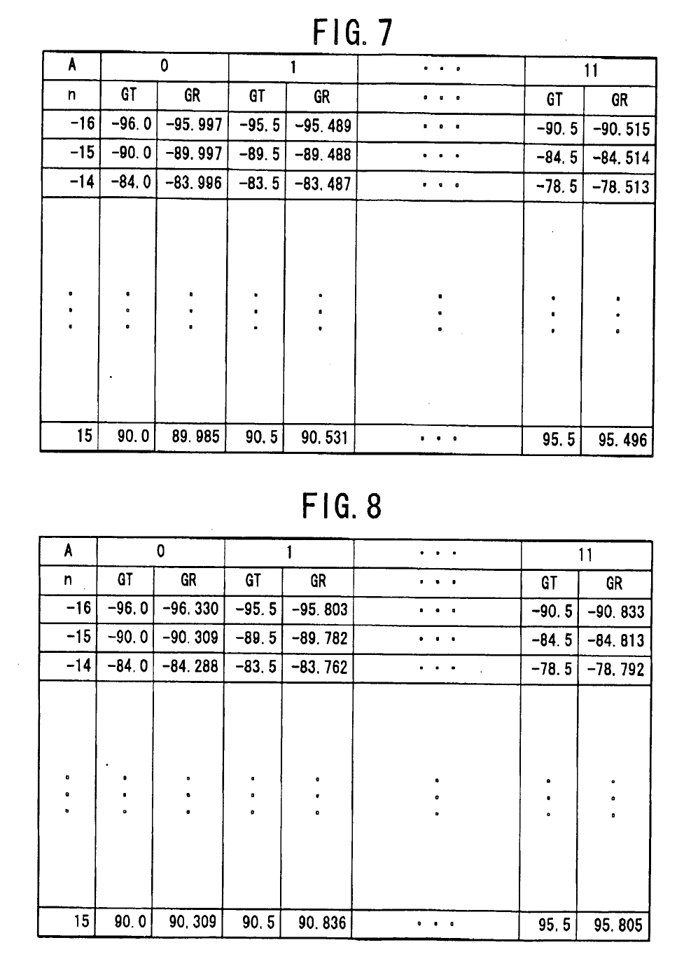

With the gain to be actually acquired being GR, in acquiring the gain GR from the mantissa data m of 5 in accordance with the equation (2), the gain GR becomes equal to −95.997 dB, as illustrated in FIG. 7.

As the gain GR is equal to −95.997 dB for the designated gain GT equal to −96.0 dB, and the error between the designated gain GT and the gain GR is 0.003 dB. In the conventional attenuator, however, as illustrated in FIG. 8, the gain GR is equal to −96.330 dB for the designated gain GT equal to −96.0 dB, and the error is 0.330 dB. Accordingly, it is obvious that the error of the attenuator according to the embodiment is smaller than that of the conventional attenuator.

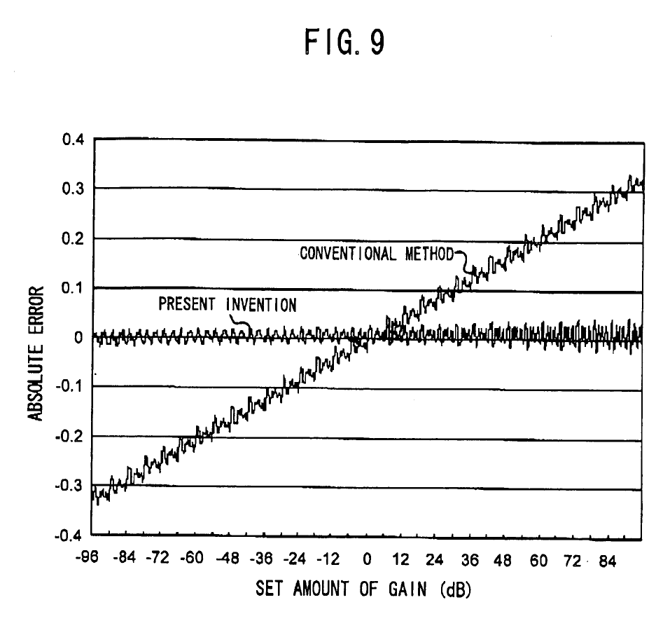

As illustrated in FIG. 9, when the error of the attenuator according to the embodiment is compared with that of the conventional attenuator for the amount of gain Gain between −96.0 and 96.0, the error of the conventional attenuator is small at around the designated gain GT of 0 dB, but increases as it moves away from the designated gain GT of 0 dB. In contrast, the error of the attenuator of the embodiment is small at the range from −96.0 to 96.0 regardless of the designated gain GT.

As described above, according to the aforementioned embodiment, the equations representing the relationship between the exponent data n and the mantissa data m for each address of mantissa A are acquired, the mantissa data m is acquired for the designated gain GT in accordance with the acquired equations, and then the gain GR is acquired.

Accordingly, the error between the designated gain GT and the actual gain GR can be reduced, thereby making it possible to control the gain with a high accuracy.

In working out the present invention, various embodiments are possible, and thus the present invention is not limited to the aforementioned embodiment.

For instance, the attenuator may acquire the mantissa-coefficient m from an approximation (6) given below.
a=(3/8)×A+(9/2),
b=(p/4)×A−(q/4) (6),

where p and q are constant numbers.

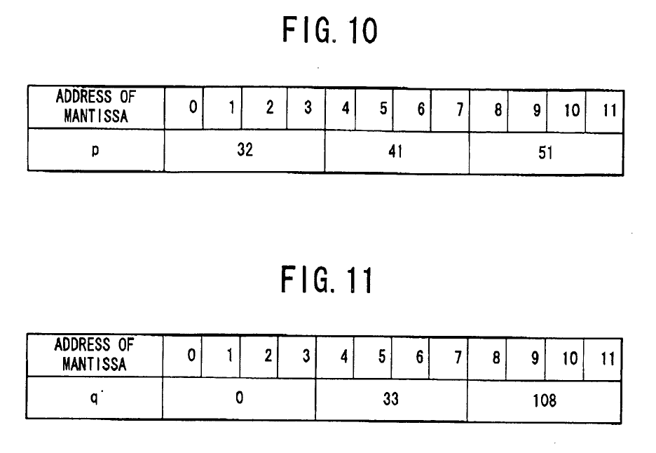

Each p and q is the coefficient set for each address of mantissa A as illustrated in FIGS. 10 and 11.

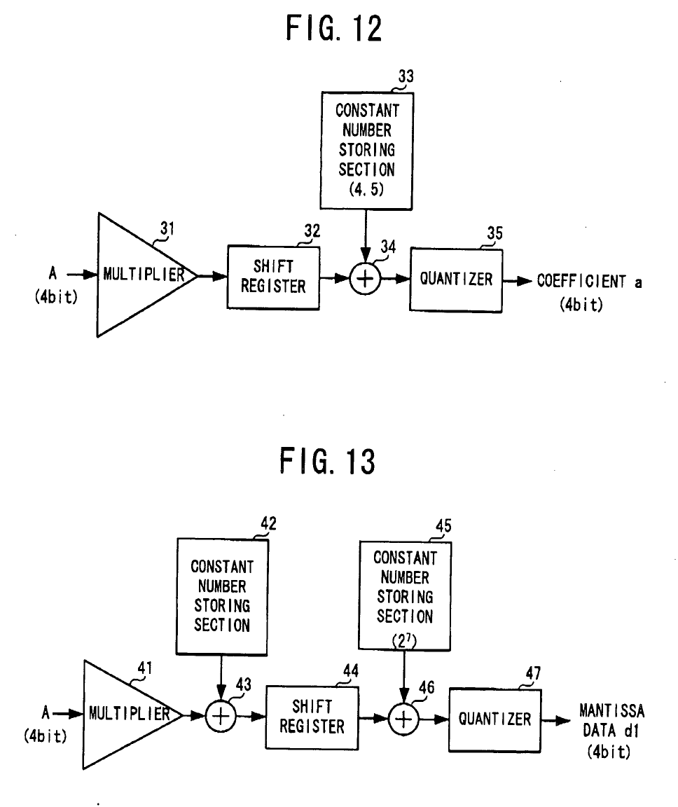

In using this approximation, as illustrated in FIG. 12, the coefficient data acquiring section 21a of the mantissa-coefficient acquiring unit 12 includes, a multiplier 31, a shift register 32, a constant-number storing section 33, an adder 34 and a quantizer 35.

The multiplier 31 multiplies the address of mantissa A by 3, and supplies the multiplied data to the shift register 32. The shift register 32 multiplies the data supplied from the multiplier 31 by ⅛ by bit-shifting that data to the right by 3 bits, and supplies the generated data to the adder 34. The constant number storing section 33 stores a constant number of 4.5.

The adder 34 acquires the constant number of 4.5 from the constant number storing section 33, and adds it to the data supplied from the shift register 32. The quantizer 35 quantizes data resulting of the addition of the adder 34. The coefficient data acquiring section 21a outputs the data quantized by the quantizer 35 as the coefficient a.

As illustrated in FIG. 13, the mantissa data acquiring section 21b includes, a multiplier 41, a constant number storing section 42, an adder 43, a shift register 44, a constant number storing section 45, an adder 46 and the quantizer 47.

The multiplier prestores a table illustrated in FIG. 10, acquires the coefficient p from this table based on the supplied address of mantissa A, multiplies the acquired coefficient p by the supplied address of mantissa A in accordance with the approximation (6), and supplies it to the adder 43.

The constant number storing section 42 prestores a table illustrated in FIG. 11. The adder 43 acquires the coefficient q from the table of FIG. 11 stored by the constant number storing section 42 based on the address of mantissa A, and adds it to the data supplied from the multiplier 41. The adder 43 supplies data resulting of the addition of the adder 43 to the shift register 44. The shift register 44 bit-shifts the data, supplied from the adder 43, to the right by 2 bits, thereby multiplying it by ¼. The shift register 44 supplies the generated data to the adder 46.

The constant number storing section 45 stores 2⁷ as the constant number. The adder 46 acquires the constant number of 2⁷, and adds it to the data supplied from the shift register 44. The quantizer 47 quantizes data resulting of the addition of the adder 46. The mantissa data acquiring section 21b outputs the data quantized by the quantizer 47 as the mantissa data d1.

The attenuator may be accompanied by a program. In this case, the program may be stored in a computer readable recording medium, such as a flexible disk, CD-ROM (Compact Disk Read-Only Memory), DVD (Digital Versatile Disk) or MO (Magneto Optical disk), distributed, and is installed on another computer to allow this computer to operate as the aforementioned means, or to execute the aforementioned processes.

Further, the program may be stored in a disk device or the like of a server on the Internet, and, for instance, embedded in a carrier wave, so that it can be downloaded into a computer.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

The present invention is based on Japanese Patent Application No. 2004-180086 filed on Jun. 17, 2004, and includes the specification, claims, drawings and abstract of the application. The disclosure of the application is hereby incorporated in the present specification by reference.

1. An attenuator for attenuating an input value in accordance with a designated attenuation, comprising:
a data storing unit which stores exponents and a number of steps between the exponents based on an accuracy of the designated attenuation in a floating-point representation, and stores address data of mantissa in association with each step;
a data acquiring unit which associates the designated attenuation with the exponents and the address data of mantissa both stored by said data storing unit, and acquires an exponent of the designated attenuation and the address data of mantissa;
a mantissa acquiring unit which acquires a mantissa of the designated attenuation from the exponent and an address of mantissa both acquired by said data acquiring unit, in accordance with a relationship between an exponent and mantissa of an attenuation, which relationship is acquired beforehand for each of the address data of mantissa; and
an attenuating unit which attenuates the input value in accordance with the attenuation set based on the exponent acquired by said data acquiring unit and the mantissa acquired by said mantissa acquiring unit.

2. The attenuator according to claim 1, wherein said mantissa acquiring unit acquires the mantissa of the designated attenuation in accordance with the relationship between an exponent and mantissa of an attenuation, which relationship is acquired beforehand for each of the address data of mantissa and represented by an equation (1) given below:
m=a_{Address}×n+b_{Address} (1),
wherein:
m is mantissa;
n is exponent; and
a_{Address} and b_{Address} are coefficients set for each address of mantissa.

3. The attenuator according to claim 2, wherein said mantissa acquiring unit prestores the coefficients a_{Address} and b_{Address} necessary for acquiring the mantissa m in a table in association with address data of mantissa, acquires the coefficients associated with the address data of mantissa acquired by said data acquiring unit, and acquires the mantissa of the designated attenuation based on the acquired coefficients and the exponent acquired by said data acquiring unit.

4. The attenuator according to claim 2, wherein said mantissa acquiring unit acquires the coefficients a_{Address} and b_{Address} necessary for acquiring the mantissa m based on a polynomial equation in which address data of mantissa is an argument, and acquires the mantissa of the designated attenuation based on the acquired coefficients and the exponent acquired by said data acquiring unit.

5. The attenuator according to claim 1, wherein said attenuating unit comprises:
an exponent attenuating unit which performs attenuation in accordance with the exponent acquired by said data acquiring unit; and
a mantissa attenuating unit which performs attenuation in accordance with the mantissa acquired by said mantissa acquiring unit.

6. The attenuator according to claim 5, wherein said exponent attenuating unit is constituted by a bit-shifting circuit which bit-shifts an input value to said exponent attenuating unit by a number of bits corresponding to the exponent acquired by said data acquiring unit.

7. The attenuator according to claim 5, wherein said mantissa attenuating unit is constituted by a multiplier which multiplies an input value to said mantissa attenuating unit by the mantissa acquired by said mantissa acquiring unit.

8. The attenuator according to claim 1, wherein a radix for representing the designated attenuation in floating-point format is 2.

9. A data signal processor which constitutes an attenuator by realizing said data storing unit, said data acquiring unit, said mantissa acquiring unit, and said attenuating unit according to claim 1.

10. A method for acquiring attenuation of an attenuator, comprising the procedures of:
storing exponents and a number of steps between the exponents based on an accuracy of a designated attenuation in a floating-point representation, and storing address data of mantissa in association with each step;
associating the designated attenuation with the stored exponents and the stored address data of mantissa, and acquiring an exponent of the designated attenuation and the address data of mantissa; and
acquiring a mantissa of the designated attenuation from the acquired exponent and an acquired address of mantissa, in accordance with a relationship between an exponent and mantissa of an attenuation, which relationship is acquired beforehand for each of the address data of mantissa.

11. A recording medium recording a program for allowing a computer to execute the procedures of:
storing exponents and a number of steps between the exponents based on an accuracy of a designated attenuation in a floating-point representation, and storing address data of mantissa in association with each step;
associating the designated attenuation with the stored exponents and the stored address data of mantissa, and acquiring an exponent of the designated attenuation and the address data of mantissa; and
acquiring a mantissa of the designated attenuation from the acquired exponent and an acquired address of mantissa, in accordance with a relationship between an exponent and mantissa of an attenuation, which relationship is acquired beforehand for each of the address data of mantissa.

12. An attenuator for attenuating an input value in accordance with a designated attenuation, comprising:
data storing means for storing exponents and a number of steps between the exponents based on an accuracy of the designated attenuation in a floating-point representation, and storing address data of mantissa in association with each step;
data acquiring means for associating the designated attenuation with the exponents and the address data of mantissa both stored by said data storing means, and acquiring an exponent of the designated attenuation and the address data of mantissa;
mantissa acquiring means for acquiring a mantissa of the designated attenuation from the exponent and an address of mantissa both acquired by said data acquiring means, in accordance with a relationship between an exponent and mantissa of an attenuation, which relationship is acquired beforehand for each of the address data of mantissa; and
attenuating means for attenuating the input value in accordance with the attenuation set based on the exponent acquired by said data acquiring means and the mantissa acquired by said mantissa acquiring means.

13. A computer data signal embedded in a carrier wave and representing a program for controlling the computer to execute the procedures of:
storing exponents and a number of steps between the exponents based on an accuracy of a designated attenuation in a floating-point representation, and storing address data of mantissa in association with each step;
associating the designated attenuation with the stored exponents and the stored address data of mantissa, and acquiring an exponent of the designated attenuation and the address data of mantissa; and
acquiring a mantissa of the designated attenuation from the acquired exponent and an acquired address of mantissa, in accordance with a relationship between an exponent and mantissa of an attenuation, which relationship is acquired beforehand for each of the address data of mantissa.
